(19) United States
(12) Patent Application Publication
(10) Pub. No.: US 2008/0049930 A1
(43) Pub. Date: Feb. 28, 2008

(54) Method and apparatus for encrypting data

(75) Inventors: Yong-Kuk You, Seoul (KR); Seong-soo Kim, Seoul (KR); Chang-yeul Kwon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/703,193

(22) Filed: Feb. 7, 2007

Related U.S. Application Data
(60) Provisional application No. 60/840,045, filed on Aug. 25, 2006.

(30) Foreign Application Priority Data
Sep. 20, 2006 (KR) 10-2006-0091185

(51) Int. Cl. H04L 9/06

(52) U.S. Cl. 380/28

(57) ABSTRACT

A method and apparatus for encrypting data. The method includes assigning bits included in data units to a plurality of data blocks based on positions of the bits in the data units and encrypting the data blocks. The apparatus includes an assignment unit which assigns bits included in the data units to a plurality of data blocks based on positions of the bits in the data units; and an encryption unit which encrypts the data blocks.

### CROSS-REFERENCE TO RELATED PATENT APPLICATION

This application claims priority from Korean Patent Application No. 10-2006-0091185, filed on Sep. 20, 2006 in the Korean Intellectual Property Office, and U.S. Provisional Patent Application No. 60/840,045, filed on Aug. 25, 2006 in the U.S. Patent and Trademark Office, the disclosures of which are incorporated herein in their entirety by reference

### BACKGROUND OF THE INVENTION

1. Field of the Invention

Methods and apparatuses consistent with the present invention relate to encrypting data, and more particularly, to encrypting data that is composed of a plurality of data units.

2. Description of the Related Art

Bits included in data may have different significances. When a predetermined bit of the data has an error, the entire data may be significantly distorted or may be slightly distorted. For this reason, it is necessary to separately manage bits that may significantly distort the entire data.

FIG. 1 illustrates data having bits of different significances.

The data of FIG. 1 is video data that expresses each pixel with red (R), green (G), and blue (B) data. It is assumed that each of the R, G, and B data is expressed with an 8-bit data unit and data of each pixel is expressed with a total of 24 bits. The R, G, and B data are values indicating the additive color degrees of red, green, and blue in the presentation of colors of a pixel.

In FIG. 1, R data 110 of a first pixel 100 is expressed with a data unit of 8 bits 111 through 118. Since an 8-bit binary can express a decimal ranging from 0 to 255, the R data 110 can express the additive color degree of red with a total of 256 levels.

When video data is transmitted and received between devices through a wired/wireless network, an error may occur so that binary values of bits are exchanged improperly during transmission.

If an error occurs in the most significant bit 118, the R data 110 has a value of ‘00101010’. The original value ‘10101010’ corresponds to a decimal of ‘170’, but the value ‘00101010’ resulting from the error corresponds to a decimal of ‘42’. As a result, a difference of ‘128’ is generated in the additive color degree of red.

If an error occurs in the least significant bit 118, the R data 110 has a value of ‘10101011’. The original value ‘10101010’ corresponds to a decimal of ‘170’, but the value ‘10101011’ resulting from the error corresponds to a decimal of ‘171’. As a result, a difference of ‘1’ is generated in the additive color degree of red.

Therefore, during transmission of the video data illustrated in FIG. 1, a user who watches the corresponding video can easily recognize an error if the error occurs in the most significant bit 111 of each of the R, G, and B data, but the user cannot easily recognize an error if the error occurs in the least significant bit 118. As such, within the R data 110 of the first pixel 100, the significance of the error differs from bit to bit.

Although the R data 110 of the first pixel 100 is taken as an example, bits likewise have different significances within the R, G, and B data of the other pixels, as well as within G data 120, and B data 130 of the first pixel 100.

In general, the reliability of data transmission and the efficiency of data transmission have a trade-off relationship. A representative example showing such a trade-off relationship is error-correction coding, in which a redundancy is added in order to detect and correct an error that occurs during data transmission. Although the probability of successful error correction is improved by increasing a redundancy in order to guarantee the reliability of data transmission, the efficiency of data transmission is degraded due to an increase in the size of the entire data that is to be transmitted.

Therefore, there is a need for a method capable of separately managing a bit that can be easily recognized by a user, like when an error occurs in a bit, such as the most significant bit 111, and a bit that cannot be easily recognized by the user, like when an error occurs in the least significant bit, thereby improving the efficiency of data transmission and minimizing errors that are most recognizable by the user.

### SUMMARY OF THE INVENTION

Exemplary embodiments of the present invention provide a method and apparatus for encrypting data, in which a data error that can be recognized by a user is minimized and data can be transmitted efficiently, and a computer-readable recording medium having recorded thereon a program for implementing the method.

According to one aspect of the present invention, there is provided a method of encrypting data that is composed of a plurality of data units. The method includes assigning bits included in each data unit to a plurality of data blocks based on positions of the bits in the data unit and encrypting the data blocks using a predetermined encryption method.

The method may further include performing error-correction coding on the encrypted data blocks using different coding rates.

The data may be RGB video data.

The encryption of the data blocks may be performed on each data block using a cipher block chaining (CBC) mode AES.

According to another aspect of the present invention, there is provided an apparatus for encrypting data that is composed of a plurality of data units. The apparatus includes an assignment unit that assigns bits included in each data unit to a plurality of data blocks based on positions of the bits in the data unit and an encryption unit that encrypts the data blocks using a predetermined encryption method.

The apparatus may further include a coding unit that performs error-correction coding on the encrypted data blocks using different coding rates.

The encryption unit may further include a determination unit that determines whether the data blocks are integral multiples of an encryption basic unit, a padding unit that selectively pads the data blocks to form integral multiples of the encryption basic unit based on the determination result, and a padding data encryption unit that encrypts the padded data blocks using the predetermined encryption method.

The padding data encryption unit may perform encryption on each padded data block using a CBC mode AES.

According to another aspect of the present invention, there is provided a computer-readable recording medium having recorded thereon a program for implementing the method of encrypting data that is composed of a plurality of data units.

### BRIEF DESCRIPTION OF THE DRAWINGS

The above and other aspects of the present invention will become more apparent by describing in detail exemplary embodiments thereof with reference to the attached drawings in which:

FIG. 1 illustrates data having bits of different significances;

FIG. 2 is a view for explaining a method of assigning data that is composed of a plurality of data units, according to an exemplary embodiment of the present invention, to a plurality of data blocks;

FIG. 3 is a flowchart illustrating a method of encrypting data according to an exemplary embodiment of the present invention;

FIG. 4 illustrates a case where a data block is not an integral multiple of an encryption basic unit;

FIG. 5 illustrates a case where data blocks padded according to an exemplary embodiment of the present invention are encrypted using a CBC advanced encryption standard (AES); and

FIG. 6 is a block diagram of an apparatus for encrypting data according to an exemplary embodiment of the present invention.

### DETAILED DESCRIPTION OF THE INVENTION

Hereinafter, exemplary embodiments of the present invention will be described in detail with reference to the accompanying drawings.

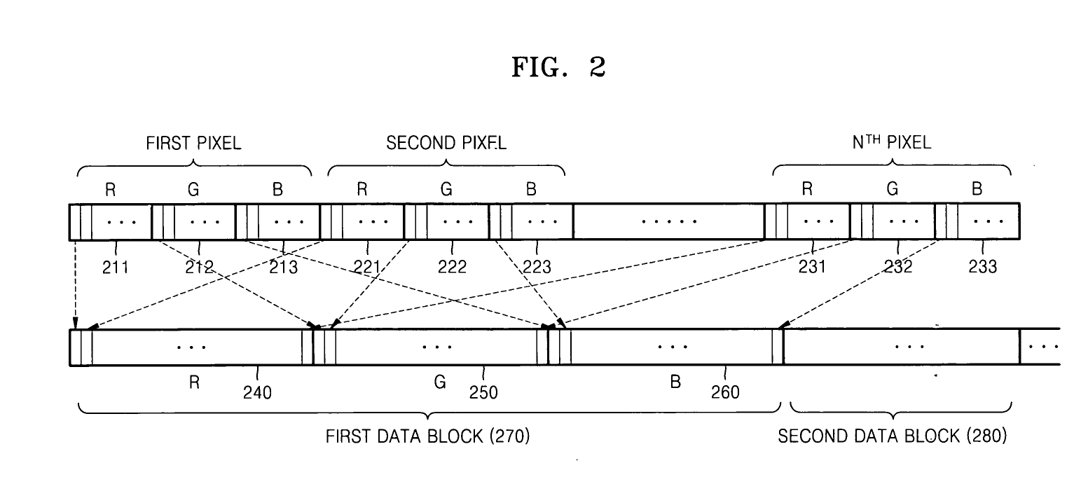

FIG. 2 is a view for explaining a method of assigning data that is composed of a plurality of data units, according to an exemplary embodiment of the present invention, to a plurality of data blocks. By using the method, bits included in each data unit are assigned to different data blocks according to their significances. If a high significant bit has an error, a user can easily recognize the error. If a low significant bit has an error, the user cannot easily recognize the error.

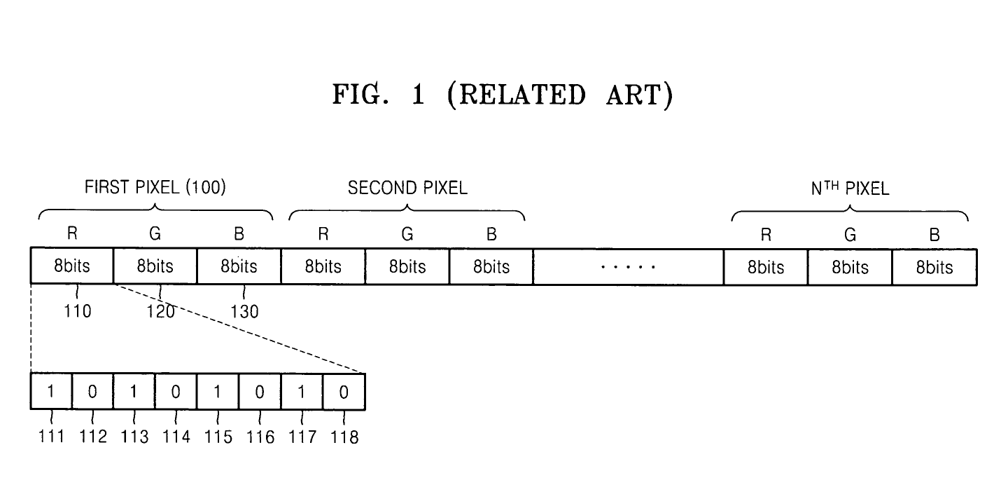

Referring to FIG. 2, data assigned to a plurality of data blocks is composed of a plurality of data units of predetermined size. In FIG. 2, like in FIG. 1, RGB video data is illustrated, in which n pixels are expressed with R, G, and B data. Each R data, G data, and B data 211-213, 221-223, or 231-233 for each pixel is a data unit. Generally, each R data, G data, and B data is expressed with 8-bit data and, thus, a data unit is composed of 8 bits. In FIG. 2, each box within a data unit indicates 1-bit data.

As described with reference to FIG. 1, an error of a most significant bit (MSB) in each data unit can be more easily recognized by the user than a least significant bit (LSB). This means that the position of a bit in a data unit determines the significance of the bit. Thus, bits in a data unit are assigned to a plurality of data blocks based on their positions in the data unit.

Most significant bits of the R data 211, 221, and 231 from among data units are assigned to a first data block 270. Next, most significant bits of the G data 212, 222, and 232 are assigned to the first data block 270. Finally, most significant bits of the B data 213, 223, and 233 are assigned to the first data block 270. The most significant bits of the RGB data all are assigned to the single data block 270 and the first data block 270 may be encrypted or error-correction coded separately as described below.

Once the most significant bits of the data units are assigned to the first data block 270, the next significant bits of the data units are assigned to a second data block 280. These operations are repeated until all the bits of the data units are assigned to data blocks. Thus, if a data unit is composed of 8 bits, bits are assigned to 8 data blocks.

In FIG. 2, after the R data 211, 221, and 231 of the video data is assigned to the first data block 270, the G data and then the B data are sequentially assigned to the first data block 270. However, various assignment methods may be used as long as the most significant bits included in data units are assigned to the single data block 270. For example, data may be assigned so that the most significant bit of the R data 211, the most significant bit of the G data 212, and the most significant bit of the B data 213 can be included in the first data block 270 by turns.

In FIG. 2, one bit of each data unit is assigned to the single data block 270. However, the number of bits of each data unit, which are assigned to a single data block, is not necessarily one and at least two consecutive bits of each data unit may be assigned to the single data block 270. For example, the most significant bits and the next significant bits of the R data 211, 221, and 231 may be assigned to the first data block 270, and the most significant bits and the next significant bits of the G data 212, 222, and 232 and the B data 213, 223, and 233 may also be assigned to the first data block 270. In this case, if a data unit is composed of eight bits, two consecutive bits of each data unit are assigned to four different data blocks.

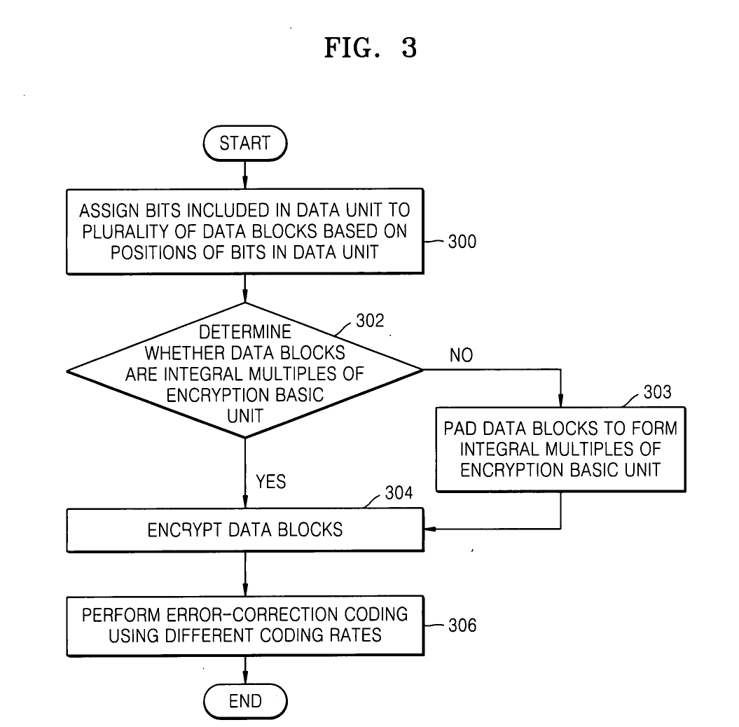

FIG. 3 is a flowchart illustrating a method of encrypting data according to an exemplary embodiment of the present invention.

In operation 300, an apparatus for encrypting data according to an exemplary embodiment of the present invention assigns bits included in each data unit to a plurality of data blocks according to the positions of the bits in the data unit. As described with reference to FIG. 2, the bits have different significances according to their positions in the data units. Thus, the bits included in the data unit are assigned to a plurality of data blocks according to their positions in the data unit in order to separately manage the bits according to their significances.

In operation 302, the apparatus for encrypting data according to the present exemplary embodiment determines whether the data blocks to which data is assigned in operation 300 are integral multiples of an encryption basic unit.

A widely used encryption method called advanced encryption standard (AES) performs encryption based on an encryption basic unit, such as 128 bits, 196 bits, or 256 bits. In this case, if data blocks are not integral multiples of the encryption basic unit, problems that will be described later occur. Therefore, it is first determined whether the data blocks are integral multiples of the encryption basic unit.

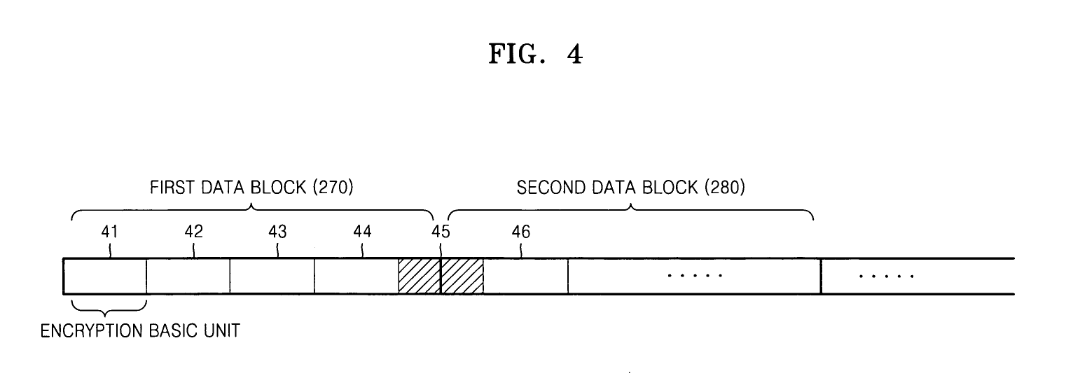

FIG. 4 illustrates a case where a data block is not an integral multiple of the encryption basic unit.

In FIG. 4, all predetermined bits of data that are rearranged with a plurality of data blocks in operation 300 are sequentially encrypted. If the first data block 270 is not an integral multiple of each encryption basic unit 41 through 46, encryption is performed on the first data block 270 and a second data block 280 at the end 45 of the first data block 270. In other words, bits of the first data block 270 and bits of the second data block 280 are encrypted together.

When the AES is used, bits of the first data block 270 and bits of the second data block 280 are encrypted as a single bit sequence. For this reason, the bits of the first data block 270 and the bits of the second data block 280 cannot be distinguished from each other in the encrypted bit sequence. As a result, data cannot be separately managed according to significances.

Referring back to FIG. 3, in operation 303, the apparatus for encrypting data according to the present exemplary embodiment uses padding in data blocks to form integral multiples of the encryption basic unit. Since the problem described above occurs if the data blocks are not integral multiples of the encryption basic unit, the data blocks are padded by ‘0’ or ‘1’ so as to make the data blocks integral multiples of the encryption basic unit.

In operation 304, the apparatus for encrypting data according to the present exemplary embodiment encrypts the data blocks using a predetermined encryption method. In other words, the apparatus for encrypting data according to the present exemplary embodiment encrypts a data block that is determined to be an integral multiple of the encryption basic unit in operation 302 or a data block that is padded so as to form an integral multiple of the encryption basic unit in operation 303.

If the data blocks are encrypted separately, separate encryption engines (e.g., an AES engine) may be used or, after a data block is encrypted, the next data block may be encrypted. In other words, encryption is performed so that an encryption result of an encryption unit composed of at least one data block is not mixed with an encryption result of another encryption unit. In particular, encryption using a cipher blocking chaining (CBC) mode AES will be taken as an example.

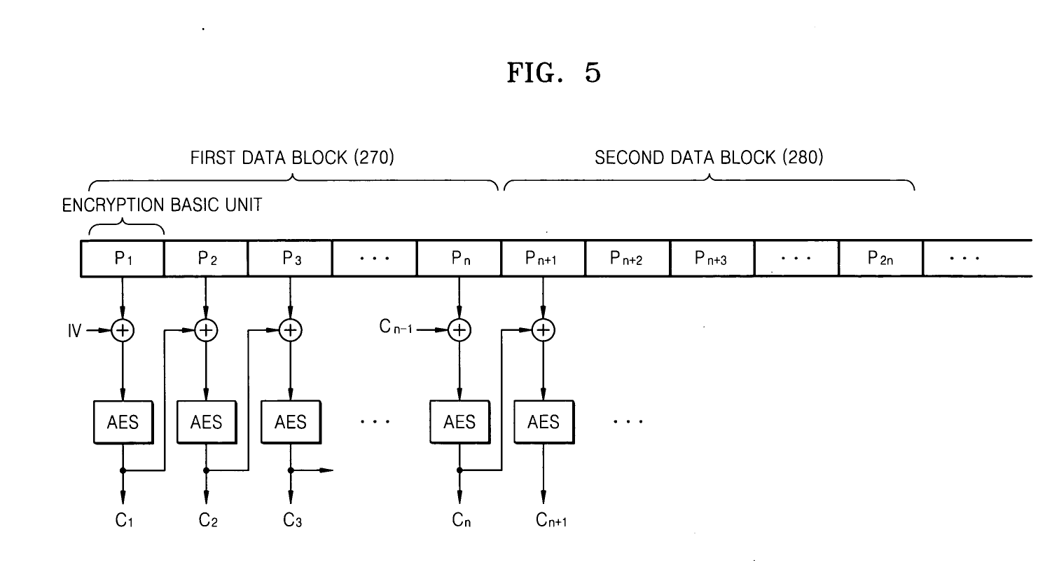

FIG. 5 illustrates a case where data blocks that are padded according to an embodiment of the present invention are encrypted using a CBC mode AES.

Referring to FIG. 5, each of the first data block 270 and the second data block 280 is padded to form n multiples of a predetermined encryption basic unit and is encrypted using the CBS mode AES.

A first encryption basic unit P₁ of the first data block 270 undergoes an exclusive OR (XOR) operation with an initial vector (IV) and then is encrypted by an AES engine. A second encryption basic unit P₂ of the first data block 270 undergoes an encryption result C₁ of the first encryption basic unit P₁ and then is encrypted by the AES engine. As a result, an encryption result of a previous encryption basic unit has an influence upon the next encryption basic unit. Therefore, an encryption result Cₙ of the last encryption basic unit Pₙ of the first data block 270 has an influence upon encryption of a first encryption basic unit Pₙ₊₁ of the second data block 280. As a result, the other encryption basic units Pₙ₊₁ through P₂ₙ of the second data block 280 are affected in series.

In an exemplary embodiment of the present invention, data is assigned to a plurality of data blocks, thereby separately managing bits of the data according to the significances of the bits. Even when the first data block 270 has an error, the second data block 280 should not be affected by the error. Therefore, the second data block 280 should not use encryption results of the first data block 270. To this end, data blocks may be encrypted using separate encryption engines or the IV may undergo the XOR operation with Pₙ₊₁ instead of Cₙ in order to resume encryption.

In operation 306, the apparatus for encrypting data according to the present exemplary embodiment performs error-correction encoding on the encrypted data blocks using different coding rates. Although the probability of successful error correction is improved by increasing a redundancy in order to guarantee the reliability of data transmission, the efficiency of data transmission is degraded due to an increase in the size of the entire data to be transmitted. The coding rate decreases as the redundancy increases and the coding rate increases as the redundancy decreases.

A large redundancy is applied to a data block that is assigned high significant bits in order to increase the probability of successful error correction and a small redundancy is applied to a data block that is assigned low significant bits in order to increase the efficiency of data transmission. By performing error-correction coding using different coding rates according to the significances of the bits, an error that can be recognized by the user can be minimized and the efficiency of data transmission can be improved.

In addition, by repeating transmission of a data block that is assigned high significant bits a predetermined number of times, the same effect as when different error-correction coding rates are used according to significances can be obtained.

In the above description, RGB video data is assigned to a plurality of data blocks according to significances, i.e., positions of bits in data units, and the data blocks are separately encrypted. However, it can be easily understood by those of ordinary skill in the art that the scope of the present invention is not limited to RGB data and embodiments of the present invention can also be applied to any data having bits of different significances.

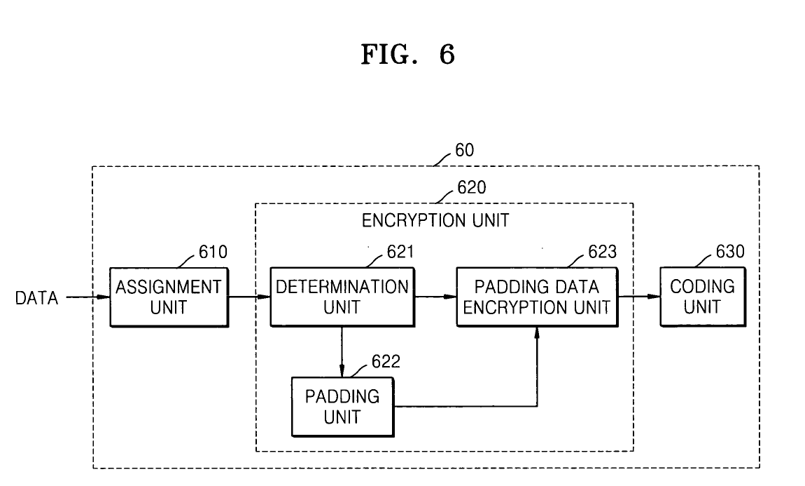

FIG. 6 is a block diagram of an apparatus for encrypting data according to an exemplary embodiment of the present invention.

Referring to FIG. 6, the apparatus includes an assignment unit 610, an encryption unit 620, and a coding unit 630. The encryption unit 620 may include a determination unit 621, a padding unit 622, and a padding data encryption unit 623.

The assignment unit 610 assigns bits included in each data unit to a plurality of data blocks according to positions of the bits in the data unit. In data composed of a plurality of data units like RGB video data, bits have different significances according to positions of the bits in the data units. Thus, the assignment unit 610 assigns the bits in the data units to the plurality of data blocks according to the positions of the bits so as to separately manage the bits in the data units according to significances of the bits.

The encryption unit 620 encrypts the data assigned by the assignment unit 610 to the plurality of data blocks using a predetermined encryption method. As described above, the AES may be used as the predetermined encryption method.

As mentioned above, the encryption unit 620 may include the determination unit 621, the padding unit 622, and the padding data encryption unit 623.

The determination unit 621 determines whether the data blocks assigned data by the assignment unit 610 are integral multiples of an encryption basic unit. The AES performs encryption based on an encryption basic unit, such as 128 bits, 196 bits, and 256 bits. In this case, if data blocks are not integral multiples of the encryption basic unit, bits around a boundary between consecutive data blocks may be encrypted as a bit sequence. In order to prevent this problem, the determination unit 621 first determines whether the data blocks are integral multiples of the encryption basic unit.

The padding unit 622 uses padding in the data blocks to form integral multiples of the encryption basic unit. Since the problem described above occurs if the data blocks are not integral multiples of the encryption basic unit, the padding unit 622 pads the data blocks with ‘0’ or ‘1’ to make the data blocks integral multiples of the encryption basic unit.

The padding data encryption unit 623 encrypts the data blocks using a predetermined encryption method. The padding data encryption unit 623 performs encryption on a data block that is determined by the determination unit 621 to be an integral multiple of the encryption basic unit without using separate padding. However, for a data block that is determined by the determination unit 621 not to be an integral multiple of the encryption basic unit, the padding data encryption unit 623 performs encryption on the data block after the data block is padded to form an integral multiple of the encryption basic unit by the padding unit 622.

The coding unit 630 performs error-correction coding on data that is encrypted by the encryption unit 620. The data blocks are error-correction coded according to different coding rates.

A large redundancy is applied to a data block assigned high significant bits in order to improve the probability of successful error correction and a small redundancy is applied to a data block assigned low significant bits in order to improve the efficiency of data transmission.

Exemplary embodiments of the present invention can also be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and the like. The computer-readable recording medium can also be distributed over a network of coupled computer systems so that the computer-readable code is stored and executed in a decentralized fashion.

As described above, according to the exemplary embodiments of the present invention, for data composed of a plurality of data units, high significant bits are separately encrypted and error-correction coded, thereby minimizing an error that can be recognized by the user and improving the efficiency of data transmission.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of encrypting data that comprises a plurality of data units, the method comprising:
assigning bits included in the data units to a plurality of data blocks based on positions of the bits in the data units; and
encrypting the data blocks.

2. The method of claim 1, further comprising performing error-correction coding on the encrypted data blocks using different coding rates.

3. The method of claim 1, wherein the data comprises red, green and blue (RGB) video data.

4. The method of claim 3, wherein the RGB video data comprises red data, green data, and blue data that are each eight-bit data units.

5. The method of claim 4, wherein the assigning of the bits comprises assigning bits included in the eight-bit data units to a plurality of data blocks based on positions of the bits in the eight-bit data units.

6. The method of claim 1, wherein the encryption of the data blocks comprises:
determining whether the data blocks are integral multiples of an encryption basic unit;
selectively padding the data blocks to form integral multiples of the encryption basic unit based on a result of the determining; and
encrypting the padded data blocks.

7. The method of claim 6, wherein the encryption basic unit is 128 bits.

8. The method of claim 6, wherein the encryption of the data blocks is performed using a 128-bit advanced encryption standard (AES).

9. The method of claim 8, wherein the encryption of the data blocks is performed using a cipher block chaining mode AES.

10. The method of claim 2, wherein a first redundancy is applied to a data block that is assigned high significant bits and a second redundancy is applied to a data block that is assigned low significant bits, and the first redundancy is larger than the second redundancy.

11. An apparatus for encrypting data that comprises a plurality of data units, the apparatus comprising:
an assignment unit which assigns bits included in the data units to a plurality of data blocks based on positions of the bits in the data units; and
an encryption unit which encrypts the data blocks.

12. The apparatus of claim 11, further comprising a coding unit that performs error-correction coding on the encrypted data blocks using different coding rates.

13. The apparatus of claim 11, wherein the data comprises red, green and blue (RGB) video data.

14. The apparatus of claim 13, wherein the RGB video data comprises red data, green data, and blue data that are each eight-bit data units.

15. The apparatus of claim 14, wherein the assignment unit assigns bits included in the eight-bit data units to a plurality of data blocks based on positions of the bits in the eight-bit data units.

16. The apparatus of claim 11, wherein the encryption unit comprises:
a determination unit which determines whether the data blocks are integral multiples of an encryption basic unit;
a padding unit which selectively pads the data blocks to form integral multiples of the encryption basic unit based on a determination result of the determination unit; and
a padding data encryption unit which encrypts the padded data blocks.

17. The apparatus of claim 16, wherein the encryption basic unit is 128 bits.

18. The apparatus of claim 16, wherein the padding data encryption unit performs encryption on the padded data blocks using a 128-bit advanced encryption standard (AES).

19. The apparatus of claim 18, wherein the padding data encryption unit performs encryption on the padded data blocks using a cipher block chaining mode AES.

20. The apparatus of claim 12, wherein the coding unit applies a first redundancy to a data block that is assigned high significant bits and applies a second redundancy to a data block that is assigned low significant bits, and the first redundancy is larger than the second redundancy.

21. A computer-readable recording medium having recorded thereon a program which implements a method of encrypting data that comprises a plurality of data units, the method comprising:
assigning bits included in the data units to a plurality of data blocks based on positions of the bits in the data units; and encrypting the data blocks.
